(19) United States
(12) Patent Application Publication
(10) Pub. No.: US 2024/0421576 A1
(43) Pub. Date: Dec. 19, 2024

(54) DUAL BUSBAR

(71) Applicant: Lisa Dräxlmaier GmbH, Vilsbiburg (DE)

(72) Inventors: Reinhold HAMMERL, Garching (DE); Jörg HIMMEL, Au (DE)

(73) Assignee: Lisa Dräxlmaier GmbH, Vilsbiburg (DE)

(21) Appl. No.: 18/703,332

(22) PCT Filed: Oct. 13, 2022
(86) PCT No.: PCT/EP2022/078471

§ 371 Date: Apr. 20, 2024

(30) Foreign Application Priority Data
Oct. 20, 2021 (DE) 10 2021 127 187.8

(51) Int. Cl. H02G 5/00

(52) U.S. Cl. CPC H02G 5/002; H02G 5/005

(57) ABSTRACT

A double busbar is disclosed comprising a first busbar and a second busbar, which are electrically insulated from one another and are arranged one above the other, the first busbar and the second busbar being stripped in a stripped region and a flexible electrical conductor element being arranged in the stripped region in place of the first busbar and the second busbar, the flexible electrical conductor element being set up to carry electrical current in the double busbar and the flexible electrical conductor element being adapted to the geometric dimensions of the double busbar.

### CROSS REFERENCE TO RELATED APPLICATIONS

This application is a national phase application of International Application No.: PCT/EP2022/078471, filed on Oct. 13, 2022, and further claims priority to German patent application 102021127187.8, filed on Oct. 20, 2021, the content of both of which is incorporated herein by reference.

### BACKGROUND OF THE INVENTION

### Field of the Invention

The present invention relates to a double busbar. In addition to the classic round conductor and single busbar systems, double busbar systems, which allow a higher current and voltage transmission, are now increasingly being used for the transmission of electrical energy in the field of electromobility. Double busbar systems comprise two geometrically identical busbars, which are arranged congruently one above the other and at a very small distance from each other. The busbars are electrically insulated from each other. This arrangement of the busbars at a small distance from each other attenuates or even cancels out the electromagnetic field between the two busbars, so that electromagnetic compatibility is greatly increased compared to a single busbar and the electromagnetic interference caused by the double busbar is kept as low as possible and energetically weak. For example, the double busbar can be used to transmit the electrical energy of a vehicle battery of an electrically powered vehicle to the electric motor of the electrically powered vehicle. Despite the high currents and voltages transmitted, this does not lead to an increased electromagnetic load on the occupants or electrical devices in the vehicle interior in the case of the double busbar.

### Description of Related Art

Due to the ever-increasing demands on installation space in vehicles, the double busbar should be arranged in a vehicle to save space. Numerous shaping processes can be used to create bends and windings in the busbars so that the double busbar adapts optimally to the vehicle body and is therefore arranged in the vehicle in a space-saving manner. It is also important that the double busbar is able to dampen vibrations that are transmitted to the double busbar by electrical components connected to the double busbar, for example.

### BRIEF SUMMARY OF THE INVENTION

One task of the invention is therefore to provide a simplified double conductor rail that can compensate for movements and vibrations.

The problem is solved by the objects of the independent claims. Advantageous further embodiments of the invention are given in the dependent claims, the description and the accompanying figures.

One aspect of the invention relates to a double busbar comprising a first busbar and a second busbar, which are electrically insulated from one another and are arranged one above the other, wherein the first busbar and the second busbar are stripped in one region and a flexible electrical conductor element is arranged in the stripped region in place of the first busbar and the second busbar, wherein the flexible electrical conductor element is arranged to carry electrical current in the double busbar and the flexible electrical conductor element is adapted to the geometrical dimensions of the double busbar.

By inserting the flexible electrical conductor element between sections of the otherwise continuously rigid double busbar, whereby the flexible power element can be arranged between the first and second busbars according to the invention, the flexibility and formability of the double busbar in the installation space of the vehicle is significantly increased compared to a continuously rigid double busbar.

Together with the second busbar, the first busbar forms the double busbar. The first busbar and the second busbar can be designed as electrically conductive flat conductor rails. The first busbar and the second busbar each comprise electrical insulation. The insulation can be made of plastic. For example, two half shells can be produced as insulation by means of an injection molding process, which are then attached to the respective conductor rail. Alternatively, the insulation can be produced as a hollow profile by means of extrusion and then the first conductor rail or the second conductor rail can be inserted into the hollow profile

The double busbar can be used to conduct electrical energy in a high-voltage system, for example in an electrically powered vehicle. For example, the double busbar can be connected to a vehicle battery of the electrically powered vehicle and used for rapid charging of the vehicle battery, in particular in the event that the battery is charged with high electrical currents. In particular, the double busbar can be used to carry electrical currents of up to 1500 amps.

The flexible electrical conductor element is attached to the first busbar and the second busbar and is used to bridge an area of the double busbar. In order to attach the flexible electrical conductor element to the first conductor rail and the second conductor rail, the first conductor rail and the second conductor rail must be stripped in a stripped area in which the flexible electrical conductor element is attached. This means that the electrical insulation of the first busbar and the insulation of the second busbar is removed in the stripped areas. The flexible electrical conductor element can then be attached to the stripped areas by means of ultrasonic welding, for example. The stripped areas can be insulated again using an insulating element after the flexible electrical conductor element has been attached. For example, a plastic cap can be pushed onto the stripped areas and fastened so that both contact protection and complete electrical insulation are provided in the stripped areas of the attachment of the first busbar and the second busbar with the flexible electrical conductor element.

The flexible electrical conductor element has the geometric dimensions of the double busbar; in particular, the width of the flexible electrical conductor element corresponds to the width of the double busbar.

The flexible electrical cable element can be used to compensate for changes in the length and position of the double busbar. It is also possible to dampen vibrations in the double busbar by means of the flexible electrical conductor element. The flexible electrical conductor element gives the double busbar flexibility with regard to all three spatial axes, whereby this flexibility of the flexible electrical conductor element can be used to dampen vibrations. An otherwise conventional rigid double busbar can also be arranged in installation spaces with curved surfaces and acute angles using the flexible electrical conductor element.

In one embodiment, the flexible electrical cable element comprises a large number of individual electrical cables. The individual electrical conductors can be combined to form a bundle. It is advantageous if the individual electrical conductors comprise the same electrical potential, so that there is no electrical field between the individual electrical conductors. The individual electrical conductors are arranged as the flexible electrical conductor element in such a way that the flexible electrical conductor element is adapted to the geometric dimensions, i.e. the size and shape, of the double busbar. The individual electrical conductors are electrically insulated from each other by insulation arranged around the individual conductors.

The number of individual electrical conductors of the flexible electrical cable element should be selected so that the flexible electrical cable element has the required current-carrying capacity of the double busbar.

The cross-sections of the individual electrical conductors of the flexible electrical cable element can be selected as required.

In one embodiment, the individual electrical conductors of the flexible electrical cable element are arranged symmetrically to one another with respect to the central axis of the flexible electrical cable element. The central axis is defined as the axis lying centrally between the first busbar and the second busbar, which lie flat against each other.

In one embodiment, the individual electrical conductors are arranged asymmetrically in relation to the central axis of the flexible electrical conductor element. This allows the distances between the individual electrical conductors to be minimized. This is particularly advantageous as it means that several individual electrical conductors with a small cross-section can be used. As a result, the flexible electrical conductor element can be designed with greater flexibility and can therefore adapt better to changes in the position of the double busbar.

In one embodiment, the individual electrical conductors of the flexible electrical cable element are held in position by means of fastening elements so that the shape of the flexible electrical cable element does not change. For example, clips can be used as fastening elements. The individual electrical conductors of the flexible electrical cable element can be arranged in the geometric dimensions of the double rail and fastened via the fastening elements in such a way that they are held in position. For example, modular clip elements can be used as fastening elements into which the individual electrical cables are clipped. The fastening elements can be manufactured using an injection molding process, for example. The fastening elements can be resilient so that the fastening elements adapt to the movement of the individual electrical conductors of the flexible electrical cable element.

In one embodiment, the flexible electrical conductor element is attached to the first busbar and the second busbar with a material bond. For example, the flexible electrical conductor element can be welded to the first busbar and to the second busbar. For example, a contact protection can also be arranged in the stripped areas in which the flexible electrical conductor element is attached to the first busbar and the second busbar. The contact protection is electrically insulating and can be plugged into the stripped areas. Alternatively, for example, the contact protection can be wrapped around the stripped areas with the flexible electrical conductor element attached. The contact protection can be a plastic element, which can be produced by injection molding.

In one embodiment, the flexible electrical conductor element comprises a connecting element with which the flexible electrical conductor element can be attached to the first busbar and to the second busbar. For example, the connecting element can be a carrier element that is connected to the first busbar and the second busbar with a material bond. The connecting element can be attached to the first conductor rail and the second conductor rail using laser welding, for example.

The fastening elements, for example the clip elements, can be attached to the connecting element. For example, the fastening elements can be glued to the connecting element. The individual electrical wires of the flexible electrical cable element can thus be simply clipped into the clip elements. The connecting element should be designed to be as stable as possible so that the fastening of the individual electrical cables is guaranteed even when the individual electrical cables move.

In one embodiment, a first flexible electrical conductor element and a second flexible electrical conductor element are attached in the stripped area, with the first flexible electrical conductor element being connected to the first busbar with a material bond and the second flexible electrical conductor element being connected to the second busbar with a material bond. The distance between the first flexible electrical conductor element and the second flexible electrical conductor element should be kept as small as possible so that the electrical field between the first flexible electrical conductor element and the second flexible electrical conductor element is kept small and low in energy.

In one embodiment, the distance between the first flexible electrical conductive element and the second flexible electrical conductive element is predetermined so that an electromagnetic field between the first flexible electrical conductive element and the second flexible electrical conductive element is kept low.

Further advantages, features and details of the invention can be seen from the following description of possible embodiments and from the drawing. The features and combinations of features mentioned above in the description as well as the features and combinations of features shown below in the figure description and/or in the figures alone can be used not only in the combination indicated in each case, but also in other combinations or on their own, without departing from the scope of the invention.

### BRIEF DESRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

In the following, an advantageous embodiment of the invention is explained with reference to the accompanying figures, wherein:

FIG. 1 depicts a top view of the double conductor rail according to an example of an embodiment;

FIG. 2 depicts a sectional view of the double busbar according to the design example; and

FIG. 3 depicts a perspective view of the double conductor rail according to the design example.

The figures are merely schematic representations and serve only to explain the invention. Identical or similarly acting elements are consistently provided with the same reference signs.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

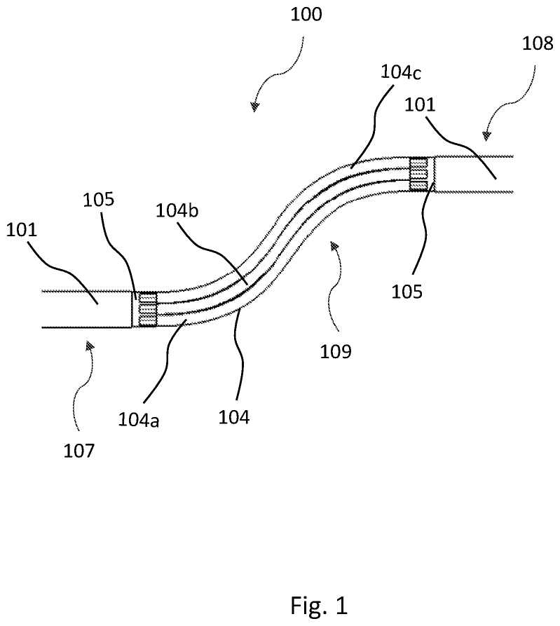

FIG. 1 shows a top view of a double busbar 100 according to a first embodiment example. The double busbar 100 comprises a first sub-region 107 and a second sub-region 108. Each of the sub-regions 107, 108 comprises a first busbar 101 and a second busbar 102. The first busbar 101 and the second busbar 102 each comprise an electrical insulation. The first busbar 101 and the second busbar 102 are arranged lying flat against each other in a longitudinal direction. In a third partial region 109 of the double busbar 100, the first busbar 101 and the second busbar 102 are interrupted and the double busbar 100 is replaced in this region by a flexible conductor element 104. The flexible electrical line element 104 comprises individual electrical lines 104a, 104b, 104c. The individual electrical conductors 104a, 104b, 104c are attached to the first busbar 101 and the second busbar 102 with a material bond. In this stripped area 105 of the fastening, the insulation is removed from the first busbar 101 and the second busbar 102.

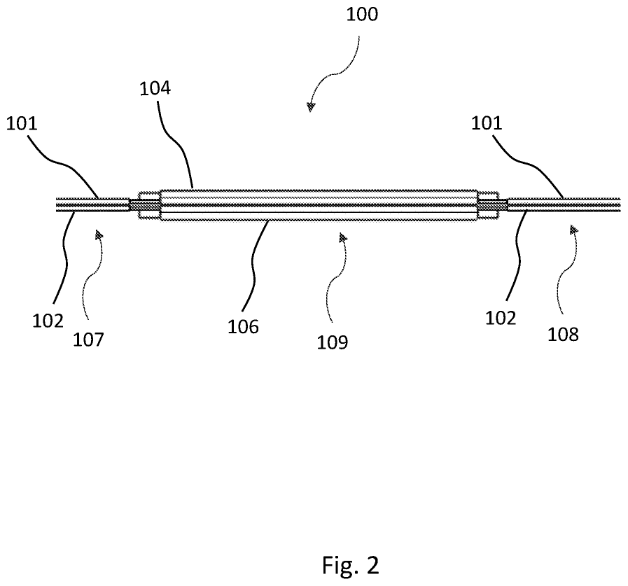

FIG. 2 shows a sectional view of the double busbar 100 according to the embodiment example. It can be seen from FIG. 2 that the flexible electrical conductor element 104 corresponds to the geometric dimensions, in particular the shape, of the double busbar 100. For this purpose, the individual electrical conductors 104a, 104b, 104c of the flexible electrical conductor element 104 are arranged as close together as possible. Depending on the current-carrying capacity and cross-sections of the individual electrical conductors 104a, 104b, 104c, the number of individual electrical conductors 104a, 104b, 104c per flexible electrical conductor element 104 can vary.

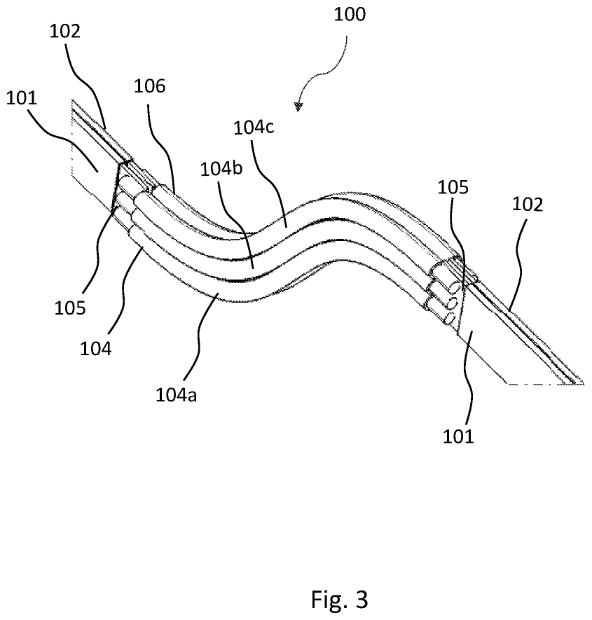

FIG. 3 shows a perspective view of the double conductor rail 100 according to the design example. The flexible electrical cable element 104 is attached to the first busbar 101. A further flexible electrical cable element 106 is attached to the second busbar 102. The flexible electrical cable element 104 and the further flexible electrical cable element 106 are arranged at a very small distance from one another. This ensures that the respective electrical fields between the flexible electrical conductor element 104 and the further flexible electrical conductor element 106 minimize or even cancel each other out, thereby greatly reducing the electrical interference emitted by the double busbar 100 compared to a conventional double busbar.

The flexible electrical conductor element 104 allows the double busbar 100 to be easily adapted to angled installation spaces. For example, the double busbar 100 can also be laid on curved and sloping surfaces and acute angles thanks to the flexible electrical conductor element 104. The flexible electrical conductor element 104 can also compensate for vibrations acting on the double busbar 100.

Since the devices and methods described in detail above are examples of embodiments, they can be modified to a wide extent by a person skilled in the art without departing from the scope of the invention. In particular, the mechanical arrangements and the proportions of the individual elements to one another are merely exemplary.

1. A double busbar, comprising,
a first busbar and a second busbar arranged electrically insulated from each other and arranged one above the other,
wherein the first busbar and the second busbar are stripped in a stripped region,
wherein a flexible electrical conductor element is arranged in the stripped region in place of the first busbar and the second busbar,
wherein the flexible electrical conductor element is arranged to carry electrical current in the double busbar, and
wherein the flexible electrical conductor element is adapted to the geometrical dimensions of the double busbar.

2. The double busbar according to claim 1, wherein the flexible electrical line element comprises a plurality of individual electrical lines.

3. The double conductor according to claim 2, wherein the individual electrical conductors are arranged symmetrically to one another.

4. The double conductor according to claim 2, wherein the individual electrical conductors are arranged asymmetrically to one another.

5. The double conductor according to claim 2, wherein the individual electrical conductors are held in position by means of fastening elements, so that a shape of the flexible electrical conductor element does not change.

6. The double conductor rail according to claim 1, wherein the flexible electrical conductor element is attached to the first conductor rail and to the second conductor rail in a materially bonded manner.

7. The double conductor rail according to claim 1, wherein the flexible electrical conductor element further comprises a connecting element configured such that the flexible electrical conductor element is attachable to the first conductor rail and to the second conductor rail.

8. The double busbar according to claim 1;
further comprising a second flexible electrical conductor element; and
wherein the first flexible electrical conductor element and the second flexible electrical conductor element are attached in the stripped region;
wherein the first flexible electrical conductor element is connected to the first busbar in a material-locking manner, and
wherein the second flexible electrical conductor element is connected to the second busbar in a material-locking manner.

9. The double busbar according to claim 8, wherein a distance between the first flexible electrical conductive element and the second flexible electrical conductive element is predetermined such that an electromagnetic field between the first flexible electrical conductive element and the second flexible electrical conductive element is kept low.
